(19) United States
(12) Patent Application Publication
(10) Pub. No.: US 2013/0110599 A1
(43) Pub. Date: May 2, 2013

(54) Purchase/Referral Rewards Program

(71) Applicant: Advershares LLC, Sarasota, FL (US)

(72) Inventor: Rogelio J. Gonzales, Sarasota, FL (US)

(73) Assignee: ADVERSHARES LLC, Sarasota, FL (US)

(21) Appl. No.: 13/667,077

(22) Filed: Nov. 2, 2012

Related U.S. Application Data
(60) Provisional application No. 61/554,607, filed on Nov. 2, 2011.

(51) Int. Cl. G06Q 30/02

(52) U.S. Cl. 705/14.16

(57) ABSTRACT

A method for administering a rewards program including receiving information relating to a purchase transaction between a purchaser and a seller, the information including at least a purchase amount, an identity of the purchaser and an identity of the seller. The method includes calculating or receiving information relating to a shared price concession, wherein the shared price concession is a portion of the purchase price, wherein the seller receives or retains the purchase amount less the shared price concession. The method further includes applying a first predetermined percentage to the shared price concession to determine a first portion thereof to be distributed to the purchaser and applying a second predetermined percentage to the shared price concession to determine a second portion thereof to be distributed to a referrer of the purchaser. The method includes applying a third predetermined percentage to the shared price concession to determine a third portion thereof to be distributed to a referrer of the referrer. Finally, the method includes distributing to a program administer, or retaining by the program administrator, a remainder of the shared price concession.

This application claims priority to U.S. Provisional Patent Application Ser. No. 61/554,607 entitled Marketing Rebate System and filed on Nov. 2, 2011, the entire contents of which are hereby incorporated by reference.

The present invention is directed to a rewards program, and more particularly, to a rewards program in which rewards can be provided to various purchasers and/or sellers in the network.

### BACKGROUND

Businesses and merchants may offer rewards and/or other incentives to various customers, users, referral sources or the like. Such rewards and discounts are often designed to incentivize further purchases and to broaden the customer base, which can ultimately provide greater revenues or other benefits to the merchant and/or customer. However, existing systems may not provide sufficiently structured rewards or incentives to purchasers and/or referral sources.

### SUMMARY

In one embodiment the present invention is a marketing system wherein a seller offers a pricing concession which is divided or shared between the purchaser, the program administrator and other referral sources.

### BRIEF DESCRIPTION OF DRAWINGS

FIG. 1 is a schematic representation of one embodiment of the present invention;

FIG. 2A is a flow chart illustrating initial sign-up and processing of purchasers, sellers, and associations in the system;

FIG. 2B is a flow chart illustrating initial sign-up and processing of purchasers, sellers, and associations in the system, from the viewpoint of a card partner;

FIG. 3 is a flow chart illustrating a sample sale transaction; and

FIG. 4 is another flow chart illustrating a sample sale transaction.

### DETAILED DESCRIPTION

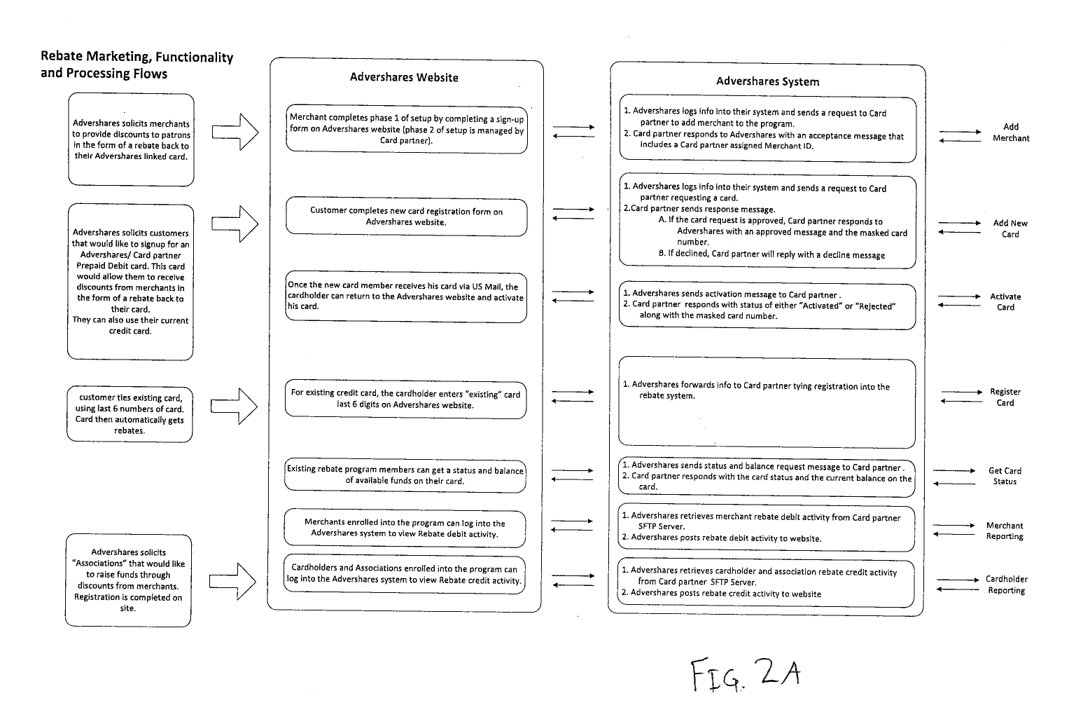

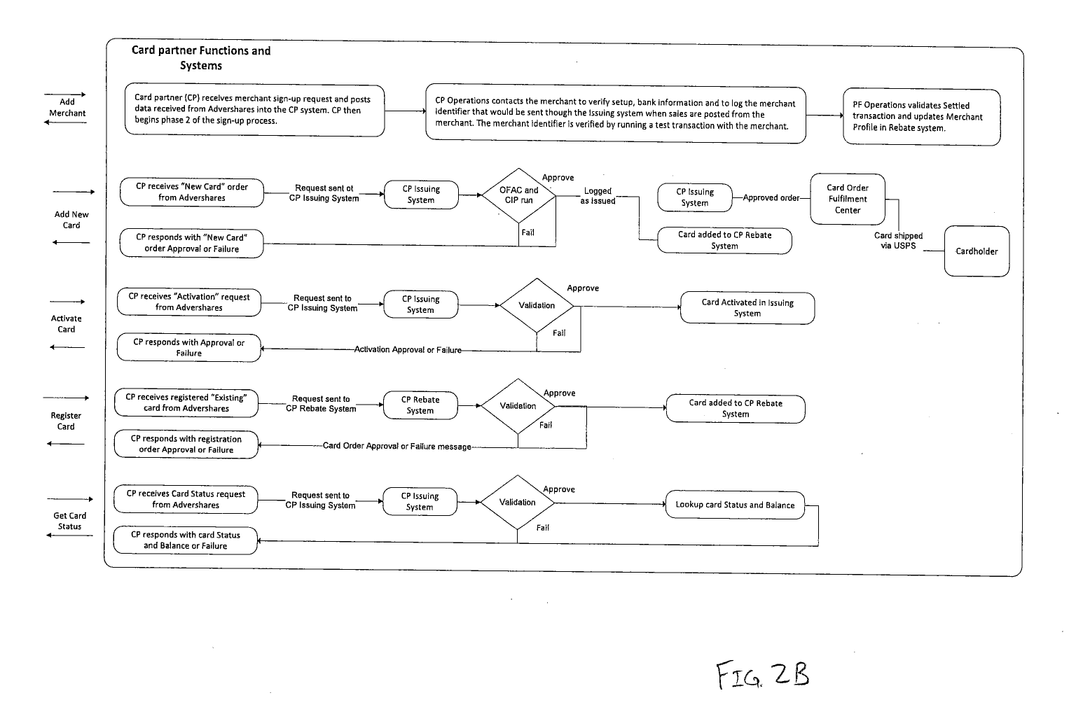

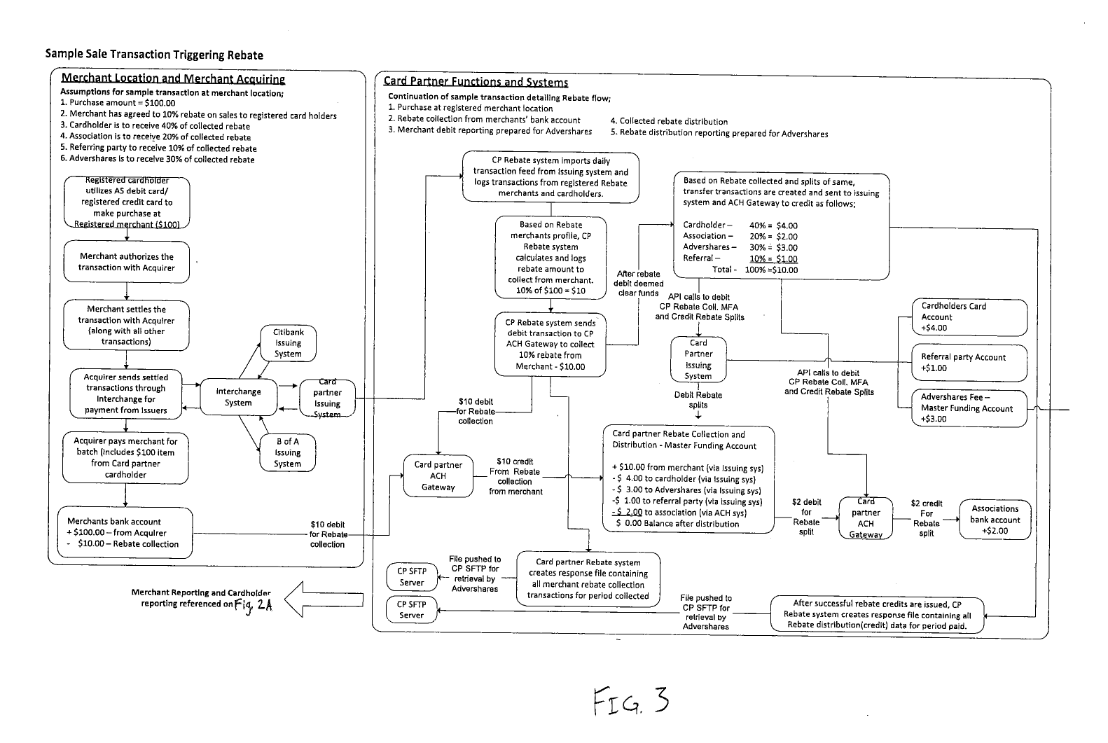

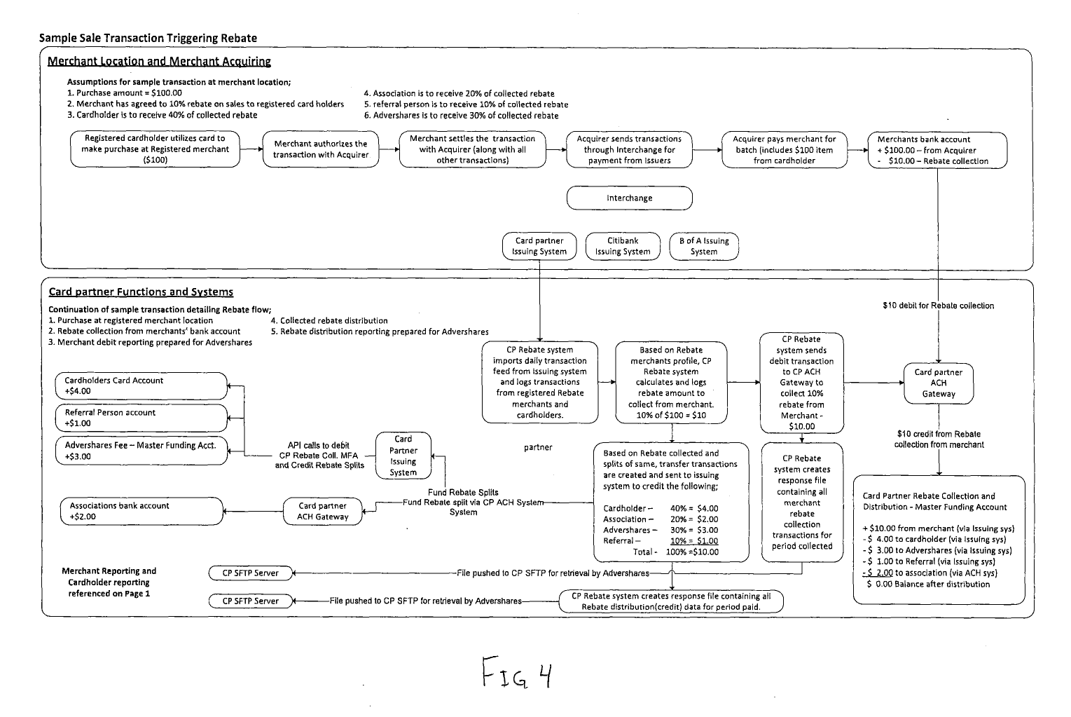

The current system or program can be used by any of a variety of customers, purchasers, consumers, buyers or the like (together termed a “purchaser” or “purchasers” herein). A purchaser can buy, purchase, lease or otherwise acquire goods, services or a combination thereof from a merchant, seller, business, provider or the like (together termed a “seller” herein). The system can be overseen and/or controlled by a program administrator, which can control the admittance of purchasers and/or sellers to the program, track purchase transactions, track referrals, provide and manage rewards, etc. The system/program administrator/program may be used interchangeably herein, and is identified as the “Advershares system” in FIGS. 2-4

The program administrator may select or approve sellers for participation in the program. A seller wishing to join the program may, for example, contact the program administrator and provide various information, including corporate or company identity, trade name, address, email and contact information, web site address, ownership, management information, number of locations, geographic scope, nature and description of goods/services offered for sale, etc. Sellers may be able to apply for participation in the program by filling out an on-line form, although the system is not limited to such a practice.

In some cases, each seller may apply for and/or be granted a zone of geographic exclusivity for that seller's goods and/or services. By way of example, a seller owning a single pizza shop in Beverly Hills may be provided exclusivity, within the program, with respect to other pizza shops such that no other pizza shops are permitted to join and/or participate in the program in Beverly Hills, or a more limited geographic area. In this manner, a wide number of sellers, offering various goods and/or services in distinct geographic areas, can be admitted to the program, either online or by other means, to meet the various needs of the purchasers. Some sellers may also be offered complete exclusivity in the program, without geographic restrictions.

Purchasers can also sign up to join and participate in the program. In particular, in order to join the program, a purchaser can provide identifying information to the program administrator such as name, address, mobile and/or home phone number, email address, contact information and the like. Purchasers can apply and/or sign up for the program by various means, including by filling out an on-line form accessed by computer, tablet, mobile device/smart phone or the like.

At the time of signing up, the purchaser may also be requested to provide information such that the purchaser can be identified in purchase transactions. For example, the purchaser may be issued a debit card associated with or administered by the program such that purchases by that purchaser can be tracked. Alternately, a purchaser can, for example, select a credit card, debit card or other financial transaction card (i.e. Visa card, MasterCard card or the like) already owned/utilized by the purchaser, which can be issued/managed/tracked by a card partner. The purchaser may provide identifying information associated with the card, such as the card number or a portion thereof (including but not limited to the last five or six digits), which can be utilized by the system/program administrator to identify the purchaser. Further alternately, or in addition, a purchaser can be issued a loyalty card which can be scanned immediately before or after a purchase transaction to identify and/or associate the purchaser with a purchase transaction.

In one case, each purchaser may be required or requested to identify a referral source, or referrer, at the time of signing up for the program. The referral source can be a person or entity who recommended the program to the purchaser or brought the program to the purchaser's attention. Since the system stores information associated with each purchaser, the referral source of the purchaser's referral source (i.e. the referrer's referrer, or the second level referrer) can also be identified and associated with the purchaser and tracked. Purchasers can be individuals, but it should also be understood that purchasers (or referrers) can also constitute business or corporate entities and the like, for example, in business-to-business transactions, as well as organizations or associations such as churches and other religious organizations, schools, charitable organizations, etc.

Once sellers and purchasers are set up in the system, the system may be able to identify, monitor and track transactions between sellers in the system and purchasers in the system (i.e. qualifying purchases or qualifying transactions), and calculate and distribute rewards as appropriate. In one case, the system may apply, to the purchase price, a shared price concession percentage, resulting in a shared price concession (“SPC”) for each qualifying transaction. For example, continuing with the example above, the pizza shop located in Beverly Hills may offer a SPC percentage of 10 percent for all qualifying transactions. When a participating purchaser visits the pizza shop and spends an amount (i.e. purchase or transaction price) in a purchase transaction, the purchaser remits payment of the full purchase price (i.e. $100) at that time. With a purchase price of $100, and a shared price concession percentage of 10%, the shared price concessions would be $10. The SPC will then be further distributed as described in greater detail below.

In one embodiment, the seller itself can determine the amount of the shared price concession percentage. This allows sellers flexibility to control the amount of shared price concession with the understanding that greater SPC percentages can drive greater volume, but can lead to lower revenues for a given transaction. Thus, allowing each seller to choose its SPC percentage can allow the sellers to apply their local market knowledge and experience, or apply their online knowledge/experience when competing globally. Alternately, the program administrator may dictate, to each seller, the shared price concession percentage. Sellers can publicize and advertise their shared price concession percentage, such as in advertising on the program web site, in advertising through standard channels, targeted advertising directed to purchasers in the program, etc. to increase awareness of the program and drive greater participation. Moreover, as will be described below, a portion of the SPC may be provided to the purchaser. Therefore, rather than advertising or promoting the shared price concession percentage, a seller may choose to advertise or promote the actual rebate percentage provided to the purchaser.

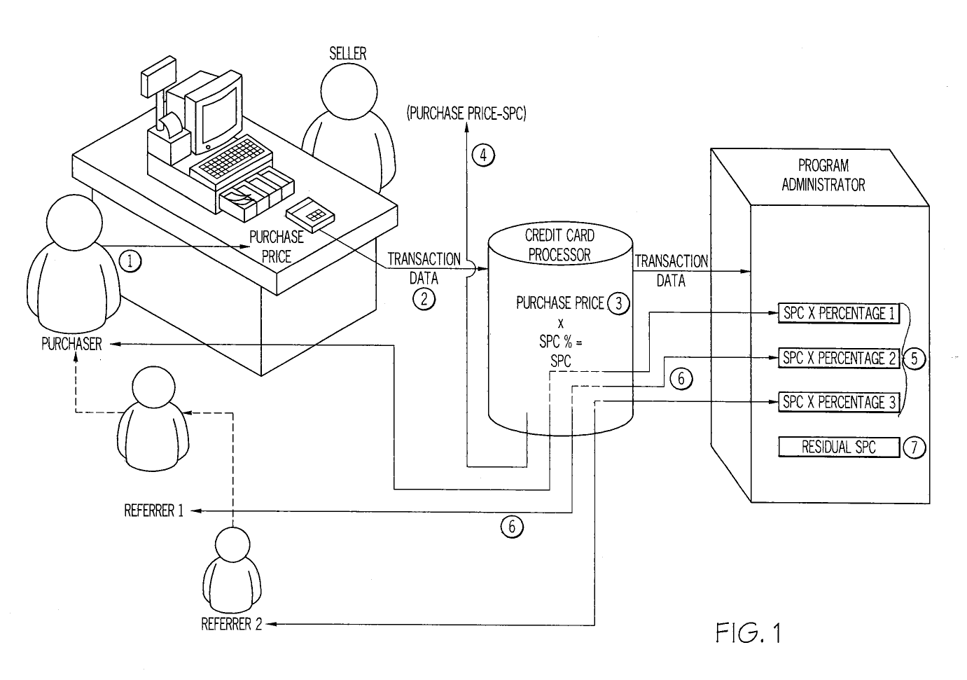

As shown in FIG. 1, a purchaser may purchase goods or services from a seller, indicated as step 1. In one case, the purchase transaction can be completed by a credit card, debit card or other financial card or account transaction carried out or assisted by a card processing terminal (“CPT”). As can be seen in FIG. 1, in one case the relevant information relating to qualifying purchase transactions are sent to a credit card processor or card partner, as part of the purchase transaction, shown as step 2. In this case the credit card processor can identify qualifying transactions based upon information provided by the program administrator, or based upon information stored by the credit card processor. Other types of transactions, such as cash, money transfer, Pay-Pal® transactions, electronic money transfer and the like can also be utilized for the purchase transaction, in which case the purchaser may be identified by a loyalty card, by account number, by self-identification or by other methods. Purchasers may also pay the seller by authorizing payment via their mobile device, and the seller may be notified of receipt of payment by a text/SMS message, email, or other communication. In any case, once a qualifying transaction is identified, information relating to the purchase transaction, such as, for example the time and date of purchase, purchase amount, identity of the purchaser, identity of the seller, etc. and any other relevant data is noted and transmitted to the program administrator and/or stored by the credit card processor.

Once the information linked to a qualifying transaction is received by the program administrator or credit card processor, the program administrator has, receives, or supplies to the credit card processor or other entity, information relating to the shared price concession percentage for that purchase transaction. The program administrator or credit card processor then multiplies the purchase price times the shared price concession percentage to arrive at the shared price concession (the third step in FIG. 1). As noted above, in the example provided herein the SPC is $10. The seller then receives an amount ($90) equal to the purchase price ($100) less the SPC ($10), shown as step 4 in FIG. 1. The shared price concession ($10) is then paid, forwarded or credited to the program administrator for processing, or dispensed by the credit card processor. At the end of each business day, the program administrator, credit card processor or the like may be provided, or may access, all transaction data associated with the CPT for each seller to identify qualifying transactions, shown as step 2. Alternately, rather than reviewing transactions at the end of each business day, transactions can be forwarded on a real-time basis.

Further alternately, sellers may provide the system/program administrator direct access to their transactions so that the system/program administrator can identify and process qualifying transactions. The system/program administrator and/or an associated third party, may also have the ability to process purchase transactions; for example using the system's software and/or app. The purchaser/consumer may, in one case, forward or authorize payment/credit to the system/program administrator. The system/program administrator can then forward or authorize payment to the seller to enable the transaction to be completed. The seller may receive a communication (i.e. text, email, etc.) from the system/program administrator indicating a sufficient and proper transfer of funds, so the seller knows to complete the transaction, or the seller may receive such a communication from an independent third party.

The program administrator or credit card processor also has, or can access, data relating to the identity of the purchaser, as well as the purchaser's referrer, and the referrer's referrer. Upon receipt of the shared price concession and/or upon receipt of the notification of qualifying purchases, the program administrator or credit card processor can determine distribution/sharing of the shared price concession by a predetermined formula or algorithm. In one case, the system calculates three amounts to be distributed/shared, shown as step 5 in FIG. 1. In particular, a first predetermined percentage of the shared price concession is calculated to be provided to the purchaser, a second predetermined percentage of the shared price concession is calculated to be provided to the purchaser's referrer (Referrer 1 in FIG. 1), and a third percentage of the shared price concession is calculated to be distributed to a referrer of the referrer (Referrer 2 in FIG. 1). Continuing with the example set forth above, in one embodiment the first percentage is 40%, such that the purchaser receives 40% of the $10 SPC ($4), the second percentage is 20%, such that the referrer receives $2, and the third percentage is 10% such that the referrer's referrer receives $1. As shown in FIG. 1, in one case the payment/rewards provided to the purchaser and both referrers is provided via the credit card processor, shown as step 6. However, as will be described in greater detail below, the reward can be provided by various other means. Any residual amounts of the shared price concession can be retained by the program administrator. In the example followed herein the residual percentage of the SPC is 30%, or $3, shown as step 7. The residual amount can be retained by the system administrator, or forwarded to the system administrator by the credit card processor. In one case the residual amount may be less than the amount paid to the purchaser to ensure sufficient rewards are provided to the purchaser and to encourage purchaser sign-up/participation.

The system described herein incentivizes purchasers to visit sellers participating in the program since the purchaser will ultimately receive a reward in the form of a percentage of the shared price concession. In addition, because each purchaser in the system can provide referrals, and receive rewards from their referrals, purchasers are incentivized to encourage friends, acquaintances and others to join the program, helping to insure rapid growth and adoption of the program. Sellers can benefit by increased sales volume and, if utilized, geographic exclusivity in the program.

In one embodiment the percentage provided to the purchaser (the first percentage) is greater than the percentage provided to the referrer (the second percentage), which is in turn greater than the percentage provided to the referrer's referrer (the third percentage). This arrangement offers the strongest incentives to purchasers to encourage buying activity, and the second strongest incentive to provide referrals to encourage overall commerce and building of the network. Maintaining the third percentage at a non-zero number also encourages participants to select new members/purchasers who may themselves bring in other new purchasers, and network building. Moreover, it should be understood that while three tiers of purchaser/referral sources are shown (i.e. purchaser, referrer 1, and referrer 2), more tiers can be added, with appropriate rewards and incentives provided as desired.

The rewards can be distributed to the purchaser and/or referrers and/or sellers by crediting their accounts, by electronic transmission, electronic payments, etc. As shown in FIG. 1, in one case the payment/rewards provided to the purchaser and to both referrers are provided via the credit card processor. However, the rewards/rebates can take other forms, such as application to rewards programs, additional discounts, credit, etc. The system/program administrator may provide a web page, portal or the like which purchasers can securely log into to view their purchase history, reward history, check the activity of their referrals, claim reward payments, etc. In one case, rewards are provided on a periodic basis, such as every 35 days. Providing a 35 day window allows reasonable time for returns, reverse charges or the like. However, if desired, rewards can be provided daily, weekly, instantaneously, or after time periods longer or shorter than 35 days.

Moreover, besides being referred by other purchasers, purchasers can also be referred/signed-up by sellers for participation in the program. In this case, if a seller refers a purchaser (i.e. for participation in the program), the seller can be treated as a referrer (e.g. Referrer 1 or Referrer 2) and receive portions of the SPC generated by the purchaser's qualifying transactions. This arrangement is advantageous in that it encourages sellers to sign up purchasers in the system, which can result in cost savings to the signed-up purchasers. In addition, the sellers can gain a revenue stream from the purchasers signed up by the seller. In some cases, sellers may set up promotional programs to sign up purchasers in the program.

The program administrator can maintain a web site or other on-line presence which purchasers and sellers can utilize to increase the effectiveness of their discounts. For example, in one case a purchaser can view the program administrator web site and search by business sector and/or geographic location so that the purchaser can identify appropriate businesses and identify discounts/rewards. The program administrator may offer to sell ranking or placement of search results to sellers, such as by the use of keyword advertising or the like so that particular sellers can be listed first, or more prominently, in a purchaser's search for particular sellers or goods/services. The search functionality can be provided by an application on a mobile device, mobile phone or the like associated with the program. Moreover, in this case, the locating functionality of the mobile device can be utilized to quickly identify participating sellers that are located near the purchaser/mobile device.

The web site, application or the like may also allow advertising, including geographically targeted advertising, by sellers so that purchasers more quickly become aware of the sellers. The program administrator/app may also have the ability to communicate advertising and special deals to purchasers by text/SMS, email, social networks or the like. The offers can take the form of an instant offer that is targeted to a particular customer due to the customer's location or other factors. In some cases the offers may be time limited.

Purchasers/members may also have the ability to transmit coupons (in some cases, with a limited amount of transmissions) to in-network friends, family, acquaintances or others. Purchasers/members may also wish to transmit special offers to in-network friends, family, acquaintances or others. Such coupons or offers may be able to be transmitted in any of a wide variety of manners, including via email, text message, social media (including Facebook, Twitter, etc.) or by other means. Purchasers/members are incentivized to transmit such coupons/offers since their friends, families and acquaintances may be referrals of the purchaser/member, and therefore any in-network purchases by the friend, family or acquaintances can result in additional rewards to the purchaser/member. In some cases, a purchaser/member can set up a particular distribution group including the purchaser/member's referrals for the purpose of transmitting such coupons/offers.

The system may also enable sellers or manufacturers to offer coupons to purchasers. For example, in one case the system can track a purchaser's purchasing behavior, which can be provided to a seller/manufacturer. The system or the seller/manufacturer can analyze the purchaser's purchase behaviour and provide future rewards/coupons. The rewards/coupons can, for example, take the form of an increased SPC %, and/or an increased percentage of the SPC offered to the purchaser. The rewards/coupons can also or instead take the form of more traditional reward such as a discount, cash back rebate or the like that is texted, emailed, or mailed to the purchasers.

The system/system administrator can also offer manufacturer coupons to its members/purchasers. For example, in one case the manufacturer may authorize the system administrator to offer a coupon (e.g. $2 off a brand of cereal offered by the manufacturer, in one case) to all or certain targeted members. The coupon, or a link or other path to the coupon may be electronically transmitted to the appropriate purchasers. The coupon may be able to be displayed on the screen of a mobile device and scanned, for example by a bar code reader or other scanning device, at check-out. The coupon may also be able to be linked to the purchaser and/or redeemed in various other manners.

In any case, once the purchaser receives the coupon/coupon offer, the consumer can also be directed to find the appropriate item. Following with the example above, when the coupon relates to a particular cereal, the system software/app may use geographic locating functionality associated with the purchaser's mobile device to determine the nearest grocery store or other store that is a participating seller, and that sells the particular brand of cereal. The system/app may also provide directions and more detailed information about the location of the couponed good (e.g. cereal), such as aisle number/location. Thus, the system provides ease of use of coupons. In addition, the use of such electronic coupons in this manner can provide a cost savings to the manufacturer, as the services of a print coupon clearinghouse are not needed.

In addition, the program administrator can use information relating to the geographic location of purchasers and sellers to provide more targeted advertising. For example, in one case, if a seller has a particular geographic zone or range of exclusivity, or a particular geographic location, the program administrator can enable the seller to communicate with all purchasers within the geographic area or adjacent/associated areas (i.e. as determined by the purchaser's registered address, detected location or the like). This advertising feature allows sellers the opportunity to provide highly targeted advertising deals, coupons and the like. In some cases, the program administrator may charge the sellers for use of one or more of these advertising/communication features.

The system/program administrator may also track purchaser and/or search activities of a purchaser in a particular geographic region so that the system/program administrator can learn or track the purchaser's likes and needs. In this manner, when the user moves to a different geographic location (as determined, for example, by identifying the location of the user's mobile device), the system/program administrator can automatically display to the purchaser similar stores or sellers, in the new geographic area, that may suit the customers' like and needs.

In addition, the program may allow purchasers to provide on-line reviews of the sellers. Purchasers may be able to provide a rating (i.e. on a 1-5 or 1-10) scale, and/or provide narrative feedback, as to overall performance and various features of the seller. In this case, however, the system may limit reviews to only those purchasers who are known to have purchased a product or service from a seller. In other words, because the program administrator tracks transactions, the system may be able to track the identity of the purchaser placing the review, and prohibit or flag a review provided by a purchaser who is not documented to have purchased from the reviewed seller. In this manner, the system helps to guard against competitors unfairly providing negative reviews, or other suspicious situations. In addition, the system may be configured such that sellers with sufficiently low ratings or reviews may be removed from participation in the program, or flagged for review for removal from the program, to ensure that only top rated sellers are maintained in the network.

In addition, the search functionality provided by the system/program, wherein a purchaser can search for sellers, may display the purchaser-generated rating next to, or as part of, the search results. In addition, or alternatively, the display order of the search results can be entirely or partly ranked based upon customer reviews/rankings. The system/search functionality can also provide more granular search results in that, for example, particular item offered for sale (such as certain items from a menu, or certain clothing from a retailer) can receive their own user rankings/reviews. The search functionality may also provide directions to the seller's nearest physical location.

Due to the high volume of data needed to be tracked, transmitted and calculated, the system can be computer-implemented. For example, a computer can be used to set up and/or administer the program, including storing and tracking the identity of and information relating to the purchasers and sellers, transaction information, reward/rebate information, shared price concessions, distribution of funds, historical data, etc. As used herein “computer” means computers, laptop computers, computer components and elements of a computer, such as hardware, firmware, virtualized hardware and firmware, combinations thereof, tablet computers, mobile devices, smart phones, or software in execution. One or more computers can reside in or on a server in various embodiments and the server can itself be comprised of multiple computers. One or more computers can reside within a process and/or thread of execution, and a computer can be localized at one location and/or distributed between two or more locations.

The computer can include a memory, a processor, and a user interface (which can include, for example, a keyboard, mouse or other cursor control device, other input devices, screen/monitor, printer, etc.) to receive inputs from, and provide outputs to, a user. The computer can be operatively coupled to a database which can store information relating to the identity of and information relating to the purchasers and sellers, transaction information, reward/rebate information, shared price concessions, distribution of funds, historical data, calculation algorithms, distribution lists, etc. As used herein “database” means any of a number of different data stores that provide searchable indices for storing, locating and retrieving data, including without limitation, relational databases, associative databases, hierarchical databases, object-oriented databases, network model databases, dictionaries, flat file/XML datastores, flat file systems with spidering or semantic indexing, and the like. Alternately, or in addition, the same information can be stored in the memory of the computer, which can also be considered a database.

Moreover, such information, including but not limited to the identity of and information relating to the purchasers and sellers, transaction information, reward/rebate information, shared price concessions, distribution of funds, historical data, calculation algorithms, distribution lists, etc. can be stored on software stored in the memory and/or the processor. The software may be able to be read/processed/acted upon by the processor. As used herein, “software” means one or more computer readable and/or executable instructions or programs that cause a computer/processor/device to perform functions, actions and/or behave in a desired manner. The instructions may be embodied in various forms such as routines, algorithms, modules, methods, threads, and/or programs. Software may also be implemented in a variety of executable and/or loadable forms including, but not limited to, stand-alone programs, function calls (local and/or remote), servelets, applets, instructions stored in a memory, part of an operating system or browser, bytecode, interpreted scripts and the like. It should be appreciated that the computer readable and/or executable instructions can be located on one computer and/or distributed between two or more communicating, co-operating, and/or parallel processing computers or the like and thus can be loaded and/or executed in serial, parallel, massively parallel and other manners. It should also be appreciated that the form of software may be dependent on various factors, such as the requirements of a desired application, the environment in which it runs, and/or the desires of a particular designer/programmer. The software may be stored on a tangible medium, such as memory, on a hard drive, on a compact disc, RAM memory, flash drive, etc., which tangible medium can exclude signals, such as transitory signals and/or non-statutory transitory signals.

The computer running the program can also be connected to the internet to receive inputs and provide outputs. The computer can communicate with the internet or other computers via computer communications. For the purposes of this application “computer communications” means communication between two or more computers or electronic devices, and can take the form of, for example, a network transfer, a file transfer, an applet transfer, an email, a hypertext transfer protocol (HTTP) message, a datagram, an object transfer, a binary large object (BLOB) transfer, and so on. Computer communication can occur across a variety of mediums by a variety of protocols, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and various other systems.

The various functions described above may be provided or contained in its own module. For example, the system may utilize a purchase transaction module for identifying and processing relevant information relating to qualifying transaction; shared price concession module for calculating a shared price concession; a calculating module for calculating the portions of the shared price concession to be distributed/shared; and a distributing module for distributing rewards, rebates or funds. Each module can be a block of software, code, instructions or the like which, when run on a computer, provide the desired functions. Each module may be able to interact with the other modules, and may not necessarily be discrete and separate from the other modules, the reader, or other components of the reader/system. The modules in the system may be functionally and/or physically separated, but can share data, outputs, inputs, or the like to operate as a single system and provide the functions described herein.

Having described the invention in detail and by reference to the various embodiments, if should be understood that modifications and variations thereof are possible without departing from the scope of the claims of the present invention.

What is claimed is:

1. A method for administering a rewards program comprising:
receiving information relating to a purchase transaction between a purchaser and a seller, the information including at least a purchase amount, an identity of the purchaser and an identity of the seller;
calculating or receiving information relating to a shared price concession, wherein the shared price concession is a portion of the purchase price, wherein the seller receives or retains the purchase amount less the shared price concession;
applying a first predetermined percentage to said shared price concession to determine a first portion thereof to be distributed to said purchaser;
applying a second predetermined percentage to said shared price concession to determine a second portion thereof to be distributed to a referrer of said purchaser;
applying a third predetermined percentage to said shared price concession to determine a third portion thereof to be distributed to a referrer of said referrer; and
distributing to a program administer, or retaining by the program administrator, a remainder of said shared price concession.

2. The method of claim 1 wherein the shared price concession is calculated by applying a shared price concession percentage to the purchase price, and wherein the seller determines the shared price concession percentage.

3. The method of claim 1 wherein the first predetermined percentage is greater than the second predetermined percentage, and the second predetermined percentage is greater than the third predetermined percentage.

4. The method of claim 1 wherein the remainder of the shared price concession distributed to or retained by the program administrator is less than the first portion of the shared price concession.

5. The method of claim 1 wherein the total of first, second and third percentage, when added together, total less than 100%.

6. The method of claim 1 further comprising the step of receiving and storing identifying information of a financial transaction card of the purchaser, and wherein the method further includes automatically receiving said information relating to said purchase transaction when the identifying information of the financial transaction card is identified and associated with the purchase transaction.

7. The method of claim 6 wherein the financial transaction card is a credit card, or a debit card exclusively associated with the rewards program.

8. The method of claim 1 further including the step of applying a fourth predetermined percentage to the shared price concession to determine a fourth portion thereof to be distributed, and wherein the method further includes the steps of distributing said first portion to said purchaser, distributing said second portion to said referrer of said purchaser, distributing said third portion to said referrer of said referrer, distributing said fourth portion, and distributing said purchase amount less the shared price concession to said seller.

9. The method of claim 1 further comprising the step of assigning said seller a zone of geographic exclusivity for a particular type of goods or services such that no other sellers in said seller's zone of geographic exclusivity are eligible to participate in the rewards program with respect to said particular type of goods or services.

10. The method of claim 1 wherein participation by the purchaser is conditioned upon the purchaser receiving, and accepting, an invitation to join the rewards program by another purchaser already in the rewards program.

11. The method of claim 1 wherein the purchaser joined the rewards programs at the invitation or notification of the referrer, and the referrer joined the rewards program at the invitation or notification of the referrer of the referrer.

12. The method of claim 1 wherein the seller is enabled to send messages or advertising to purchasers only in a zone of geographic exclusivity of the purchaser or adjacent areas.

13. The method of claim 1 wherein purchasers are enabled to search for sellers that participate in the program, and wherein sellers are enabled to purchase increased positions in results of the search.

14. The method of claim 1 wherein purchasers are enabled to provide reviews of sellers, and wherein such reviews are restricted only to purchasers who are indicated to have purchased goods or services from the reviewed seller.

15. A method for administering a rewards program comprising:
calculating or receiving information relating to a shared price concession associated with a purchase transaction between a purchaser and a seller, wherein the shared price concession is determined by applying a predetermined shared price concession percentage to a purchase price associated with the purchase transaction;
applying a first predetermined percentage to said shared price concession to determine a first portion thereof to be distributed to said purchaser;
applying a second predetermined percentage to said shared price concession to determine a second portion thereof to be distributed to a referrer of said purchaser; and
applying a third predetermined percentage to said shared price concession to determine a third portion thereof to be distributed to a referrer of said referrer, wherein a program administrator receives or retains a remainder of said shared price concession, and the seller receives or retains the purchase amount less the shared price concession.

16. The method of claim 15 further comprising the steps of distributing said first portion to said purchaser, distributing said second portion to said referrer of said purchaser, distributing said third portion to said referrer of said referrer, and distributing said purchase amount less the shared price concession to said seller.

17. The method of claim 15 wherein the seller determines the shared price concession percentage.

18. The method of claim 15 wherein the seller has a zone of geographic exclusivity for a particular type of goods or services which are involved in the purchase transaction.

19. The method of claim 15 wherein the first predetermined percentage is greater than the second predetermined percentage, and the second predetermined percentage is greater than the third predetermined percentage.

20. Tangible media including computer-readable instructions configured to cause a computer reading the instructions to carry out the following steps:
calculate or receive information relating to a shared price concession associated with a purchase transaction between a purchaser and a seller, wherein the shared price concession is determined by applying a predetermined shared price concession percentage to a purchase price associated with the purchaser transaction;
apply a first predetermined percentage to said shared price concession to determine a first portion thereof to be distributed to said purchaser;
apply a second predetermined percentage to said shared price concession to determine a second portion thereof to be distributed to a referrer of said purchaser; and
apply a third predetermined percentage to said shared price concession to determine a third portion thereof to be distributed to a referrer of said referrer, wherein the seller receives or retains the purchase amount less the shared price concession, and a program administrator receives or retains, a remainder of said shared price concession.

21. A rewards program system comprising:
a receiving module configured to receive information relating to a purchase transaction between a purchaser and a seller, the information including at least a purchase amount, an identity of the purchaser and an identity of the seller;
a calculating or receiving module configured to calculate or receive information relating to a shared price concession, wherein the shared price concession is a portion of the purchase price; and
a portion module configured to:
apply a first predetermined percentage to said shared price concession to determine a first portion thereof to be distributed to said purchaser;
apply a second predetermined percentage to said shared price concession to determine a second portion thereof to be distributed to a referrer of said purchaser; and
apply a third predetermined percentage to said shared price concession to determine a third portion thereof to be distributed to a referrer of said referrer.

22. The reward program system of claim 21 wherein said receiving module, said calculating or receiving module, and said portion module and are all operated by a processor.
